(19) United States
(12) Patent Application Publication
(10) Pub. No.: US 2018/0098367 A1
(43) Pub. Date: Apr. 5, 2018

(54) SYSTEM AND METHOD FOR PROXIMITY BASED PAIRING AND INFORMATION EXCHANGE BETWEEN MOBILE DEVICES

(71) Applicant: Masa Pezdirc, Los Angeles, CA (US)

(72) Inventor: Masa Pezdirc, Los Angeles, CA (US)

(21) Appl. No.: 15/286,554

(22) Filed: Oct. 5, 2016

(51) Int. Cl. H04W 76/02; H04W 4/00; H04W 4/02

(52) U.S. Cl. CPC H04W 76/023; H04W 4/025; H04W 4/008

(57) ABSTRACT

The present invention relates to a system and methods for exchanging information between a plurality of mobile devices by pairing the two mobile devices based on proximity of the two mobile devices that are in ready to exchange mode within the network. The two different methods to initiate the pairing can work simultaneously or independently. One utilizes a set of actions within a specific time and the angle of the devices facing each other, as the other utilizes a unique sound and its recognition. Once paired, the server sends an information to the each of the said mobile devices.

### FIELD OF THE INVENTION

The present invention generally relates to exchanging information between mobile devices, and more particularly relates to pairing the mobile devices based on the proximity for exchanging information between the paired mobile devices.

### BACKGROUND OF THE INVENTION

Generally, transferring the data from one mobile device to another mobile device in proximity requires wireless communication connectivity such as Wi-Fi, Bluetooth, NFC or airdrop technologies and the data transfer can often be platform specific. In order to exchange data easily and independent of the platform supported by the devices, there is a need for a simpler way of exchanging information between the mobile devices without the need to use any complex method mentioned in prior art and with minimum user interaction with the device.

Most prior art is describing pairing using shaking/bumping, either mobile device motion or body motion in order to pair the correct mobile devices within proximity. This results in complex and often unreliable outcomes. Some other methods comprise of a lot of user interactions, such as receiving pairing messages that need confirmations, entering secret and/or pin codes, etc. Therefore, prior methods for sharing data do not provide a streamline and simple method, which limits user interactions, while sharing data securely amongst users.

### SUMMARY OF THE INVENTION

The present invention relates to a system that works with two methods that can work simultaneously or independently to seamlessly execute the pairing of the mobile devices based on the proximity of the mobile devices connected to a network. The system comprises of a server and downloadable application(s). Our methods are the only methods, which will pair the mobile phones with one click by launching the app, without the need for the user from the beginning to the end of the process, to ever look at the device. The user simply places the phones within proximity. Once devices are paired the user receives a sound/vibrate confirmation, and then performs a motion activity to confirm the transfer.

An embodiment of the present invention includes a method that establishes a secure communication channel between user devices to share data seamlessly and with limited user effort. The method is implemented for exchanging information between the paired mobile devices, based on the proximity of the mobile devices in conjunction with a specified period of time, at a specific geographic and positional angular range wherein the method comprises of registering a user with a clients' application installed on each of the mobile devices, launching the application and receiving proximity of each of the mobile devices based on a GPS, or any other location identifier technique. As the specific action is preformed within a specified period of time the server pairs the correct two devices and sends the information from one device to another

In an alternative embodiment, the second method can be implemented in conjunction or independently of the first, where both devices make a unique sound that the gyroscope sensors, acting as microphones for sound detection, identify and proceed to initiate the correct pairing. The unique sound created by the system can range from a human audible frequency to a low frequency sound, which may not detectable by human hearing.

Both methods allow the server to track the motion activity of each of the plurality of mobile devices through the accelerometer sensors and to initiate exchange of information across the mobile devices that are paired. Further, the methods allow the server to receive information from each of the mobile devices that are paired, and to send the exchanged information to each of the paired devices to be displayed as a summary of exchanged information through the clients' application.

The system takes a time and location stamp of the exact position and time when the exchange of the information happened. This allows the user to have the location and time data of the interaction stored in the system, enabeling the smart search engine, where data can be search via name, date or time of the exchange.

### BRIEF DESCRIPTION OF DRAWINGS

FIG. 1 illustrates a working overview of the system for easily exchanging information between a plurality of mobile devices based on the determining the two mobile devices in ready to exchange mode within proximity.

FIG. 2 illustrates a flow-chart that explains the first method of exchanging information between a plurality of mobile devices that are paired based on the specific geographic and positional angular range determined between the two mobile devices in proximity.

FIG. 3 illustrates a flow-chart that explains the second method of exchanging information between a plurality of mobile devices that are paired based on the unique sound determined by gyroscope between the two mobile devices within proximity.

FIG. 4 illustrates a system overview of components used for implementing the methods of exchanging information between a plurality of mobile devices that are paired based on the determining the two mobile devices in ready to exchange mode within proximity.

FIG. 5 illustrates a first method where devices are in position for pairing of the two devices to exchange information and initiating the transfer of the information between the paired devices through the server application.

FIG. 6 illustrates a second method where devices are in position for pairing of the two devices to exchange information and initiating the transfer of the information between the paired devices through the server application.

### FIGURE DESCRIPTION

100—A system overview for implementing information exchange between a plurality of the mobile devices that are paired based on the proximity of the two devices.
101—A network within which the system works
102—A server application
103—Clients' application installed on the user's mobile devices
104a, 104b, 104c, and 104d—User's mobile devices
300—A System overview of components
301—An Application module
302—A Display module
303—A Geographic and Position angular module
304—A Location Identifier module
305—A Position Identifier module
306—A Readiness Identifier module
307—A Time Identifier module
308—A Communication module
309—A Sound module
400—A Sound Identifier module
401a, 401b—A Plurality of mobile devices identified within the proximity
402—A Pairing module

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

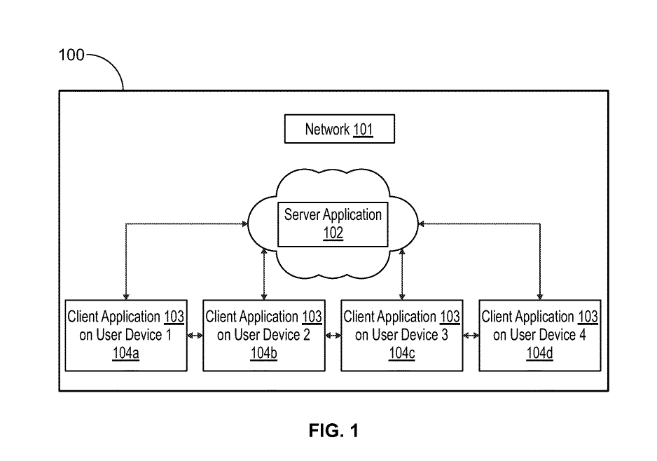

In an embodiment, a mobile device refers to a device on which the client application 103 (with reference to FIG. 1) can be installed for implementing information exchange between a plurality of mobile devices that are paired based on the proximity of the mobile devices 104a, 104b, 104c, and 104d (with reference to FIG. 1).

The terms “registered user” and “user” are used interchangeably in the disclosed invention.

Referring to FIG. 1 illustrates a working overview of the system 100 (with reference to FIG. 1) for exchanging information between a pair of mobile devices 104a, 104b, 104c, and 104d, wherein the mobile devices 104a, 104b, 14c, and 104d can be paired using two methods for determining the correct plurality of mobile devices to be paired by the system 100. In an embodiment, the system 100 comprises of a server application 102 installed on a server of a network 101, and the client application 103 installed on the user's mobile devices 104a, 104b, 104c, and 104d.

In an embodiment, a user's account can be registered with the client application 103 installed on the user's mobile devices 104a, 104b, 104c, and 104d. Upon registering with the client application 103, the server application 102 communicates with the client application 103 for exchanging information between mobile devices 104a, 104b, 104c, and 104d that are connected based on the two methods determined for pairing the plurality of mobile devices 104a, 104b, 104c, and 104d.

In an embodiment, the server application 102 is configured to determine the position of each of the plurality of mobile devices 104a, 104b, 104c, and 104d and the proximity of each of the plurality of mobile devices 104a, 104b, 104c, and 104d with different location identifier techniques respectively. Further, the geographic and position angular range is determined with the proximity, accelerometer sensor and gyroscope through the client application 103 installed on the plurality of mobile devices 104a, 104b, 104c, and 104d being shared with the server application 102. Further, based on this information, the server application 102 is configured to pair the mobile devices 104a, 104b, 104c, and 104d.

In an embodiment, the client application 103 is configured to release a unique sound of each of the plurality of mobile devices 104a, 104b, 104c, and 104d and the proximity of each of the plurality of mobile devices 104a, 104b, 104c, and 104d with different location identifier techniques respectively. Further, the unique sound can be identified via gyroscope through the client application 103 installed on the plurality of mobile devices 104a, 104b, 104c, and 104d being shared with the server application 102.

In an embodiment, the server application 102 is configured to receive the unique sound information that is sent from the client application 103. Further, based on this information, the server application 102 is configured to pair the mobile devices 104a, 104b, 104c, and 104d.

The server receives the information about the readiness of the devices 104a, 104b, 104c and 104d to exchange the information via a special screen, wherein the device 104a, 104b, 104c and 104d is on a special screen mode on the display screen of the mobile devices 104a, 104b, 104c and 104d to alert the server about the readiness of the paired mobile devices 104a, 104b, 104c and 104d to exchange information.

In an embodiment, the server application 102 is configured to establish a connection between the paired mobile devices 104a, 104b, 104c and 104d for exchanging information. For example, as depicted in the figure a connection is established between the paired mobile devices 104a and 104b, and the mobile devices 104c and 104d.

Further, the server application 102 is configured to initiate information exchange between the paired mobile devices 104a, 104b, 104c and 104d after determining the readiness for exchanging information determined on each of the paired mobile devices 104a, 104b, 104c and 104d.

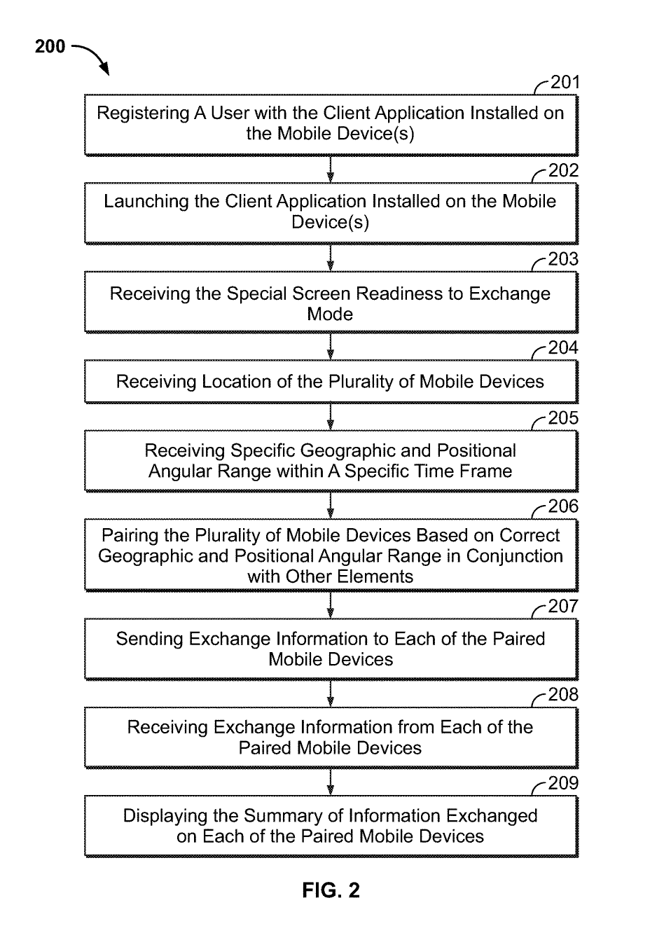

In an embodiment, a method of exchanging information between a plurality of mobile devices is shown in FIG. 2, implemented in the system 100 as shown in FIG. 1. Referring to FIG. 2 illustrates a flow-chart 200 that discloses the first method of exchanging information between a plurality of mobile devices that are paired based on the proximity between the two mobile devices (401a, 401b) within the network 101. Initially at step 201, the method allows the user to register with the client application 103 installed on the mobile device(s) (401a, 401b). At step 202, the method requires the user to launch the client application. At step 203, a special screen is displayed on the two mobile devices to alert the server application about the readiness to exchange the information. Further, at step 204 the method determines the location of the plurality of mobile devices (401a, 401b) that are intending to exchange information within the network 101. Further, at step 205 the server receives a specific geographic and positional angular range within a specific time frame. At step 206, the method pairs the plurality of mobile devices (401a, 401b) that are intending to exchange information within the network 101 through a proximity, accelerometer sensor and a gyroscope associated with the mobile devices (401a, 401b). At step 207, the method starts exchanging the information through the server application 102. Further, at step 208, the method exchanges the information with the client application 103 installed on the paired mobile devices (401a, 401b) and at step 209, the method displays the summary of information exchanged on the client application 103 installed on the paired mobile devices (401a, 401b).

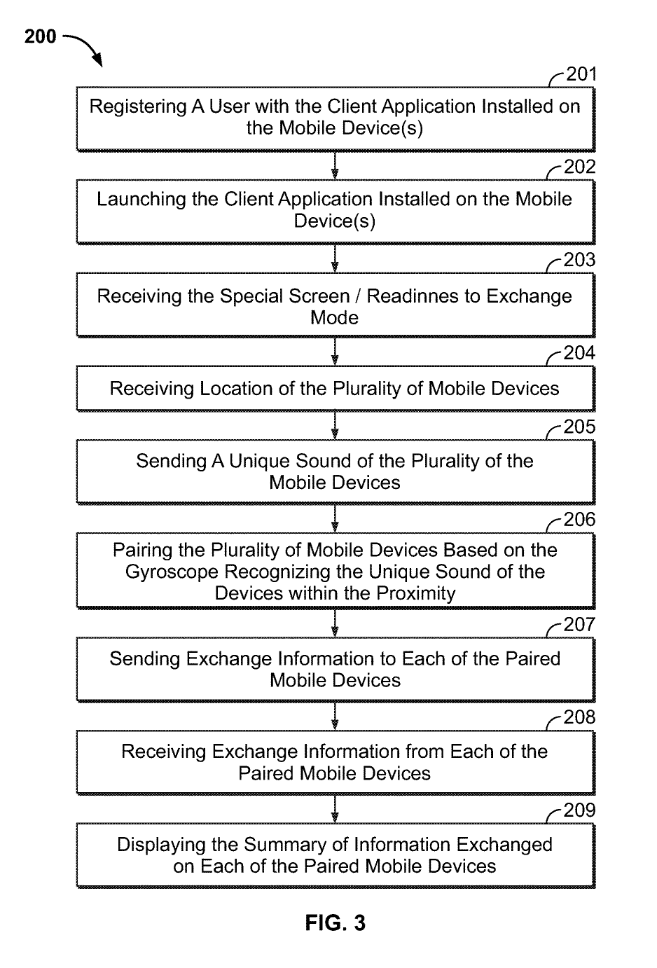

In an embodiment, a method of exchanging information between a plurality of mobile devices is shown in FIG. 3, implemented in the system 100 as shown in FIG. 1. Referring to FIG. 3 illustrates a flow-chart 200 that explains the second method of exchanging information between a plurality of mobile devices that are paired based on the proximity between the two mobile devices within the network 101. Initially at step 201, the method allows the user to register with the client application 103 installed on the mobile device(s) (401a, 401b). At step 202, the method requires the user to launch the client application. At step 203, a special screen is displayed on the two mobile devices to alert the server application about the readiness to exchange the information. Further, at step 204 the method determines the location of the plurality of mobile devices (401a, 401b) that are intending to exchange information within the network 101. Further, at step 205 the method sends a unique sound through the client application 103 installed on devices (401a, 401b) that are intending to exchange information within the network 101 while a gyro sensor detects the unique sound coming from the other device within a network to determine the proximity of the two mobile devices (401a, 401b). At step 206, the method pairs the two mobile devices (401a, 401b) based on the proximity and the sound recognition of the plurality of the mobile devices (401a, 401b) determined within the network 101. At step 207, as the method pairs the plurality of mobile devices (401a, 401b), the method starts exchanging the information through the server application 102. Further, at step 208, the method exchanges the information with the client application 103 installed on the paired mobile devices (401a, 401b) and at step 209, the method displays the summary of information exchanged on the client application 103 installed on the paired mobile devices (401a, 401b).

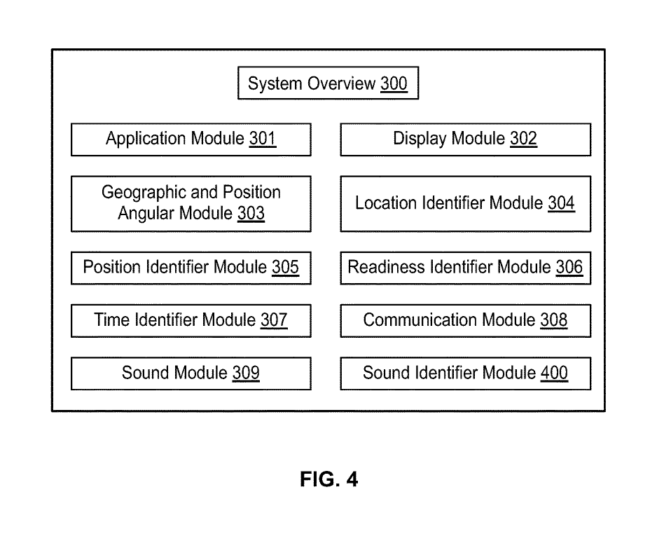

Referring to FIG. 4 illustrates a system overview 300 of components used for implementing the method of exchanging information between a plurality of mobile devices 401a, 401b that are paired based on the proximity of the plurality of mobile devices 401a, 401b, wherein the system comprises of the following components: an Application module 301, a Display module 302, a Geographic and Position angular module 303, a Location Identifier module 304, a Position Identifier module 305, a Readiness Identifier module 306, a Time Identifier module 307, a Communication module 308, a Sound module 309 and a Sound Identifier Module 400. In an embodiment, the Application module 301 is configured to install the client application 103 (shown in FIG. 1) on a plurality of mobile devices 401a, 401b (shown in FIG. 1) within the network 101 (shown in FIG. 1), wherein the client application 103 allows the user to register with the application 103, and the server application 102 (shown in FIG. 1) is installed on the network server for validating the user account and facilitating information exchanging service across a plurality of mobile devices 401a, 401b. In an embodiment, the Display module 302 is configured to display the special screen mode as well as summary of information exchanged through the client application 103 within the network 101. In an embodiment, the Geographic and Possition angular module 303 is configured to determine the position of the two mobile devices 401a, 401b facing each other within a specific time frame within the network 101, which is sent to the server application 102 for pairing the mobile devices 401a, 401b. In an embodiment, the Location Identifier module 304 is configured to identify the location of the plurality of mobile devices 401a, 401b by using any of the existing location identifier techniques, such as a Global Positioning System (GPS). In an embodiment, the Position Identifier module 305 is configured to identify the position of the plurality of mobile devices 401a, 401b for exchanging information. The plurality of mobile devices 401a, 401b can be placed facing each other for exchanging information. In an embodiment, the Readiness Identifier module 306 is configured to determine the readiness factor associated with the plurality of mobile devices 401a, 401b, for exchanging information through the client application 103 within the network 101. In an embodiment, the Time Identifier module 307 is configured to identify the limited time window for pairing of the mobile devices to determine the two devices ready to exchange. In an embodiment, the Communication module 308 is configured to establish a communication between the paired mobile devices and to transfer data within the network 101. In an embodiment, the Sound module 309 is configured to create a unique sound for each user within the same location to be sent through client application 103 to mobile devices 401a, 401b. In an embodiment Sound Identifier module 400 is configured through gyroscope sensor to identify the other user's unique sound and identify the two devices 401a, 401b that are ready to be paired.

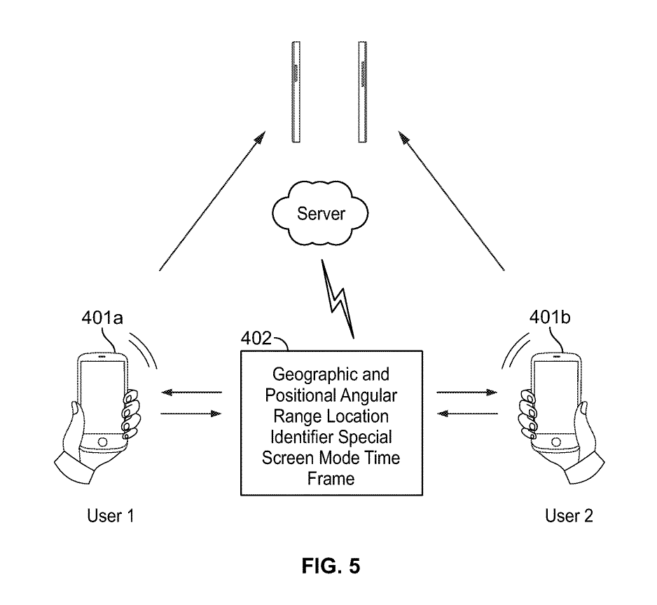

Referring to FIG. 5, illustrates the first method for the two mobile devices in proximity to be paired to exchange information. As depicted in FIG. 5, readiness of plurality of mobile devices 401a, 401b (for pairing the mobile devices 401a, 401b) is determined by using the proximity, accelerometer sensor and gyroscope along with other location identifier techniques, position identifier and special screen mode 402 within a specified duration of time.

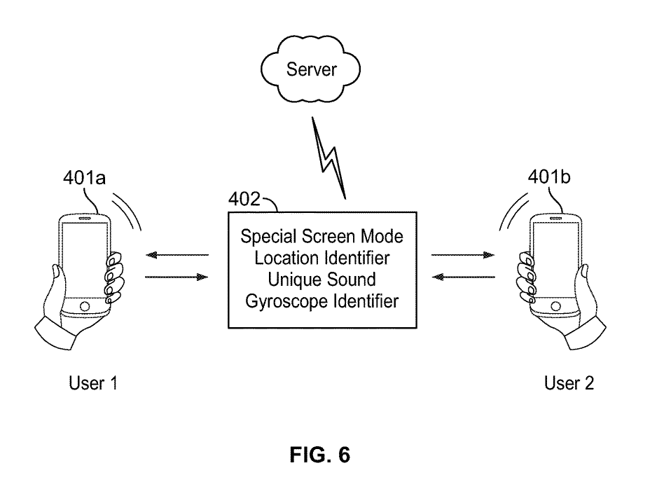

Referring to FIG. 6 illustrates the second method for the two mobile devices 401a, 401b in proximity to be paired to exchange information. As depicted in picture, the proximity of plurality of mobile devices 401a, 401b (for pairing the mobile devices 401a, 401b) is determined by client application 103 releasing a unique sound. The unique sound could be a sound not heard with normal human hearing such as low frequency sound. Further, the proximity of mobile devices 401a, 401b to be paired can be determined by other factors associated with the mobile devices 401a, 401b such as special screen mode and any location identifier. In an embodiment, the gyroscope 402 can be on the users mobile device 401a, 401b is configured to detect a unique sound and to alert a server 102 about the two devices with client application 103 to be paired.

1. A system for exchanging information between a plurality of mobile devices based on proximity of two mobile devices within a network, wherein said system comprises of a local server application, a clients' application is configured to:
identify the location of each of said plurality of mobile devices by the client applications and determine the two closely placed devices within proximity of one another;
determine availability of plurality of mobile devices closest based on specific geographic and positional angular range of each of said devices within the space through said gyroscope and/or other sensors;
determine the two devices in closest proximity of each of said plurality of mobile devices through said GPS and other location identifier techniques;
determine the readiness for exchanging information between two devices based on the two devices preforming a specific action within a specific time frame;
determine the readiness for exchanging information between two devices based on the angle of the two devices facing each other;
pair the two devices based on the proximity, action within a time frame and the angle of the devices within a space;
establish a connection between two devices, that are paired, for exchanging information;
initiate information exchange between the two mobile devices, which are paired.

2. A system for exchanging information between a plurality of mobile devices based on proximity of two mobile devices within a network, wherein said system comprises of a local server application, a clients' application is configured to:
identify the devices closest within proximity and determine the location of each of said plurality of mobile devices by the client applications;
pair the two devices in the proximity of each of said plurality of mobile devices that the system has identified, based on the unique sound that the devices make that is identified and detected through said gyroscope sensor which acts as a microphone.

3. The system as claimed in claims 1 and 2, wherein said system allows a user to register with the client application installed on each of said plurality of mobile devices.

4. The system as claimed in claims 1 and 2, wherein more than 2 devices may be paired at once if criteria set forth above is set forth and initiator approves.

5. The system as claimed in claims 1 and 2, wherein said system is configured to identify the location of each of said plurality of mobile device, using a global positioning system (GPS) along with the other location identifier techniques.

6. The system as claimed in claim 4, wherein the location determined for each of said plurality of mobile devices is shared with the server application within the network.

7. The system as claimed in claim 1, wherein the position determined (gyroscope) for each of said plurality of mobile devices within the limited time frame, is shared with the server application to exclude any devices that are not in the desired position.

8. The system as claimed in claim 1 and 2, wherein the readiness for exchange is determined (special screen mode) for each of said plurality of mobile devices within the limited time frame when shared with the server application to exclude any other devices that are not in the desired ready to exchange mode.

9. The system as claimed in claim 1, wherein the proximity is determined (proximity sensor) for each of said plurality of mobile devices within the limited time frame when shared with the server application to exclude any devices that are not within proximity.

10. The system as claimed in claims 1 and 2, wherein the two paired mobile devices may be notified by vibrate or sound initiated by the server application

11. The system as claimed in claim 2, wherein the two paired mobile devices may perform an action for sharing with the server application.

12. The system as claimed in claims 1 and 2, where said server application initiates the information transfer.

13. The system as claimed in claims 1 and 2, wherein exchanging information through the client application comprises of sharing information, location details, and the exact time associated with the moment when the exchange happened.

14. The methods 1 and 2 as claimed in claim 12, wherein the method takes a snap shot of the location using a global positioning system (GPS) along with the time determined by Universal Time Coordination (UTC) format at the time when the exchange happened.

15. The methods 1 and 2 as claimed in claim 12, wherein the system within the application provides a search engine where the information that was exchanged can be accessed and found by entering the time, location, or the name of the exchanged information.
